(19) United States
(12) Patent Application Publication
(10) Pub. No.: US 2026/0238318 A1
(43) Pub. Date: Aug. 13, 2026

(54) Handling Beam Failure

(71) Applicant: Telefonaktiebolaget LM Ericsson (publ), Stockholm (SE)

(72) Inventors: Min Wang, Luleå (SE); Zhang Zhang, Beijing (CN); Jan Christoffersson, Luleå (SE); Nithin Srinivasan, Cologne (DE)

(21) Appl. No.: 19/155,758

(22) PCT Filed: Feb. 16, 2023
(86) PCT No.: PCT/CN2023/076412

§ 371 Date: Aug. 12, 2025

(51) Int. Cl. H04B 7/06; H04L 1/1812; H04L 5/00; H04W 76/28; H04W 92/18

(52) U.S. Cl. CPC H04B 7/06964; H04L 1/1812; H04L 5/0053; H04W 76/28; H04W 92/18

(57) ABSTRACT

According to an aspect, there is provided a method performed by a first wireless device (10). The first wireless device (10) is configured to send communications to a second wireless device (20) via a first configured beam (30) and receive communications from the second wireless device (20) via a second configured beam (40). The method comprises transmitting (801) beam failure recovery, BFR, signalling to the second wireless device (20) or a network node (85) if beam failure is detected for the second configured beam (40). Transmitting the BFR signalling to the second wireless device (20) comprises transmitting the BFR signalling via the first configured beam (30) and/or via at least one different beam.

### TECHNICAL FIELD

This disclosure relates to communications between wireless devices that use one or more beams, and in particular to techniques for handling a failure of a beam.

### BACKGROUND

### NR Operation in Mm-Wave Bands

Mobile broadband will continue to drive the demands for higher overall traffic capacity and higher achievable end-user data rates in a wireless access network. Several scenarios in the future will require data rates of up to 10 Gbps in local areas. These demands for very high system capacity and very high end-user date rates can be met by networks with distances between access nodes ranging from a few meters in indoor deployments up to roughly 50 m in outdoor deployments, i.e. with an infra-structure density considerably higher than the densest networks of today. The wide transmission bandwidths needed to provide data rates up to 10 Gbps and above can likely only be obtained from spectrum allocations in the millimeter (mm)-wave band. High-gain beamforming, typically realized with array antennas, can be used to mitigate the increased pathloss at higher frequencies. Such networks are referred to as New Radio (NR) systems in the following.

As the operating frequency of wireless networks increases and moves to millimeter wave territory, data transmission between nodes suffers from high propagation loss, which is proportional to the square of the carrier frequency. Moreover, millimeter wave signal also suffers from high oxygen absorption, high penetration loss and a variety of blockage problems. On the other hand, with the wavelength as small as less than a centimeter, it becomes possible to pack a large amount (tens, hundreds or even thousands) of antenna elements into a single antenna array with a compact formfactor, which can be widely adopted in a network equipment and a user device. Such antenna arrays/panels can generate narrow beams with high beam forming gain to compensate for the high path loss in mm-wave communications, as well as providing highly directional transmission and reception pattern. As a consequence, directional transmission and reception are the distinguishing characteristics for wireless networks in mm-wave bands. In addition, a transmitter/receiver can typically only transmit/receive in one or perhaps a few directions at any given time.

NR supports a diverse set of use cases and a diverse set of deployment scenarios. The later includes deployment at both low frequencies (100s of MHz), and very high frequencies (mm waves in the tens of GHz). Two operation frequency ranges are defined in NR Rel-15: Frequency Range 1 (FR1) from 410 MHz to 7125 MHz and Frequency Range 2 (FR2) from 24.250 GHz to 52.6 GHZ.

### Beam Failure Detection and Recovery

As described in clause 5.17 of 3rd Generation Partnership Project (3GPP) TS 38.321v 16.6.0 , the Medium Access Control (MAC) entity may be configured by Radio Resource Control (RRC) per Serving Cell with a beam failure recovery procedure which is used for indicating to the serving gNB of a new Synchronisation Signal Block (SSB) or Channel State Information-Reference Signal (CSI-RS) when beam failure is detected on the serving SSB(s)/CSI-RS(s). Beam failure is detected by counting beam failure instance indication from the lower layers to the MAC entity. If beamFailureRecoveryConfig is reconfigured by upper layers during an ongoing Random Access procedure for beam failure recovery for SpCell, the MAC entity shall stop the ongoing Random Access procedure and initiate a Random Access procedure using the new configuration.

RRC configures the following parameters in the BeamFailureRecoveryConfig, BeamFailureRecoverySCellConfig, and the RadioLinkMonitoringConfig for the Beam Failure Detection and Recovery procedure:
beamFailureInstanceMaxCount for the beam failure detection;
beamFailureDetectionTimer for the beam failure detection;
beamFailureRecoveryTimer for the beam failure recovery procedure;
rsrp-ThresholdSSB: an RSRP threshold for the SpCell beam failure recovery;
rsrp-ThresholdBFR: an RSRP threshold for the SCell beam failure recovery;
powerRampingStep: powerRampingStep for the SpCell beam failure recovery;
powerRampingStepHighPriority: powerRampingStepHighPriority for the SpCell beam failure recovery;
preambleReceivedTargetPower: preambleReceivedTargetPower for the SpCell beam failure recovery;
preambleTransMax: preambleTransMax for the SpCell beam failure recovery;
scalingFactorBI: scalingFactorBI for the SpCell beam failure recovery;
ssb-perRACH-Occasion: ssb-perRACH-Occasion for the SpCell beam failure recovery using contention-free Random Access Resources;
ra-ResponseWindow: the time window to monitor response(s) for the SpCell beam failure recovery using contention-free Random Access Resources;
prach-ConfigurationIndex: prach-ConfigurationIndex for the SpCell beam failure recovery using contention-free Random Access Resources;
ra-ssb-OccasionMaskIndex: ra-ssb-OccasionMaskIndex for the SpCell beam failure recovery using contention-free Random Access Resources;
ra-OccasionList: ra-OccasionList for the SpCell beam failure recovery using contention-free Random Access Resources;
candidateBeamRSList: list of candidate beams for SpCell beam failure recovery;
candidateBeamRSSCellList: list of candidate beams for SCell beam failure recovery.

The following UE variables are used for the beam failure detection procedure:
BFI_COUNTER (per Serving Cell): counter for beam failure instance indication which is initially set to 0.

The MAC entity shall for each Serving Cell configured for beam failure detection:
1>if beam failure instance indication has been received from lower layers:
   2>start or restart the beamFailureDetectionTimer;
   2>increment BFI COUNTER by 1;
   2>if BFI COUNTER>=beamFailureInstanceMaxCount:
      3>if the Serving Cell is SCell:
         4>trigger a BFR for this Serving Cell;
      3>else:
         4>initiate a Random Access procedure (see clause 5.1) on the SpCell.
1>if the beamFailureDetection Timer expires; or
1>if beamFailureDetectionTimer, beamFailureInstanceMaxCount, or any of the reference signals used for beam failure detection is reconfigured by upper layers associated with this Serving Cell:
   2>Set BFI_COUNTER to 0.
1>if the Serving Cell is SpCell and the Random Access procedure initiated for SpCell beam failure recovery is successfully completed (see clause 5.1):
   2>set BFI_COUNTER to 0;
   2>stop the beamFailureRecoveryTimer, if configured;
   2>consider the Beam Failure Recovery procedure successfully completed.
1>else if the Serving Cell is SCell, and a PDCCH addressed to C-RNTI indicating uplink grant for a new transmission is received for the HARQ process used for the transmission of the BFR MAC CE or Truncated BFR MAC CE which contains beam failure recovery information of this Serving Cell; or
1>if the SCell is deactivated as specified in clause 5.9:
   2>set BFI_COUNTER to 0;
   2>consider the Beam Failure Recovery procedure successfully completed and cancel all the triggered BFRs for this Serving Cell.

The MAC entity shall:
1>if the Beam Failure Recovery procedure determines that at least one BFR has been triggered and not cancelled for an SCell for which evaluation of the candidate beams according to the requirements as specified in TS 38.133[11 ] has been completed:
   2>if UL-SCH resources are available for a new transmission and if the UL-SCH resources can accommodate the BFR MAC CE plus its subheader as a result of LCP:
      3>instruct the Multiplexing and Assembly procedure to generate the BFR MAC CE.
   2>else if UL-SCH resources are available for a new transmission and if the UL-SCH resources can accommodate the Truncated BFR MAC CE plus its subheader as a result of LCP:
      3>instruct the Multiplexing and Assembly procedure to generate the Truncated BFR MAC CE.
   2>else:
      3>trigger the SR for SCell beam failure recovery for each SCell for which BFR has been triggered, not cancelled, and for which evaluation of the candidate beams according to the requirements as specified in TS 38.133 [11] has been completed.

All BFRs triggered for an SCell shall be cancelled when a MAC PDU is transmitted and this PDU includes a BFR MAC CE or Truncated BFR MAC CE which contains beam failure information of that SCell.

### Beam Management in NR

Beam management is used to keep track of suitable beams for transmission and reception. Typically, networks using analog beamforming with fixed grid-of-beam transmission schemes rely on testing beam candidates continuously by, e.g., evaluating UE measurement reports. The NR beam management framework constitutes a set of methods to give the network the possibility to inform the UE about spatial relations between beams and to facilitate UE side beam tracking.

Before starting the Random Access Channel (RACH) procedure, the User Equipment (UE) measures on a set of Synchronisation Signal (SS)/Physical Broadcast Channel (PBCH) blocks and chooses a suitable one. Random access is then transmitted on the RACH resources indicated by the selected SS/PBCH block. The corresponding beam will be used by both the UE and the network to communicate until connected mode beam management is active. The network infers which SS/PBCH block beam was chosen by the UE without any explicit signalling. This procedure for finding an initial beam from SS is often denoted P1. The network can use the SS/PBCH block beam as an indication of which (narrow) CSI-RS beams to try, i.e. the candidate set of narrow CSI-RS beams for beam management is based on the best SS/PBCH block beam. Once CSI-RS is transmitted, the UE measures the Reference Signal Received Power (RSRP), and reports the result to the network. If the network receives a CSI-RSRP report from the UE where a new CSI-RS beam is better than the old used to transmit Physical Downlink Control Channel (PDCCH)/Physical Downlink Shared Channel (PDSCH), the network updates the serving beam for the UE accordingly, and possibly also modifies the candidate set of CSI-RS beams. The network can also instruct the UE to perform measurements on SS/PBCH blocks. If the network receives a report from the UE where a new SS/PBCH block beam is better than the previous best SS/PBCH block beam, a corresponding update of the candidate set of CSI-RS beams for the UE may be motivated. This refinement procedure is often referred to as P2.

Once in connected mode, the UE is configured with a set of reference signals. Based on its own measurements, the UE determines which Receive (Rx) beam is suitable to receive each reference signal in the set. The network then indicates which reference signals are associated with the beam that will be used to transmit PDCCH/PDSCH, and the UE uses this information to adjust its Rx beam when receiving PDCCH/PDSCH. PDCCH and PDSCH beams can be identical-if not, additional signalling is needed. When the network has updated its serving Transmit (Tx) beam for the UE, the UE may need to update its Rx beam. To accomplish this, the network repeatedly transmits CSI-RS on the new serving Tx beam while the UE varies its Rx beam. The UE can then select the best Rx beam and associate it with the measured reference signal. This procedure is often referred to as P3.

In a transitory period, the UE Rx beam is typically wide, and the beams used to transmit downlink (DL) reference signals and the corresponding PDCCH/PDSCH may not be identical but are guaranteed to be equivalent for UE reception purposes. Information of which reference signal should be used for Rx beam refinement and tracking purposes may be updated as needed by the network through MAC Control Element (CE) signalling. The network can also let its Tx beam follow the UE as it moves. If the UE supports beam correspondence, it can derive its Tx beam from the Rx beam used to receive a certain reference signal from the same node. However, beam correspondence is never perfect, and performance can always be improved by Sounding Reference Signal (SRS) sweeping. The network (NW) can then measure on the received SRS symbols and indicate to the UE which one it prefers, which the UE then maps to a Tx beam. Solutions based on beam correspondence and SRS sweeping are applicable both to Physical Uplink Control Channel (PUCCH) and physical Uplink Shared Channel (PUSCH).

### NR Sidelink

NR sidelink communication was specified by 3GPP in Release 16 (Rel-16). The NR sidelink (SL) is an evolution of the Long Term Evolution (LTE) sidelink, in particular of the features introduced in Release 14 (Rel-14) and Release 15 (Rel-15) for vehicle-to-everything (V2X) communication. Some of the most relevant features of the NR sidelink are the following:
Support for unicast and groupcast transmissions, in addition to broadcast transmissions, which were already supported in LTE.
Support for Hybrid Automatic Repeat Request (HARQ) feedback over the SL for unicast and groupcast. This feedback is conveyed by the receiver UE to the transmitted UE using the physical sidelink feedback channel (PSFCH). This functionality is new in NR compared to LTE.
To alleviate resource collisions among different sidelink transmissions launched by different UEs, it enhances channel sensing and resource selection procedures, which also lead to a new design of physical channels carrying the sidelink control information (SCI). The new design of the SCI simplifies coexistence between releases by grouping together all the information related to resource allocation (which is critical for coexistence) in a single channel with a robust, predefined format. Other control information is carried by other means, in a more flexible manner.
Grant-free transmissions, which are supported in NR uplink transmissions, are also provided in NR sidelink transmissions, to improve the latency performance.
To achieve a high connection density, congestion control and thus the Quality of Service (QoS) management is supported in NR sidelink transmissions.

### SUMMARY

There currently exist certain challenge(s). In 3GPP, SL transmission in FR2 is being proposed by companies for Release 18 (Rel-18) SL topics.

In Uu, beam failure detection and recovery has been designed since NR Rel-15. The procedure is used by the UE to report a beam failure (BF) event to the gNB, meanwhile, the UE also indicates a candidate beam to the gNB in the procedure. By doing this, the gNB can instruct the UE to change to a different beam.

For SL transmission in FR2, beam forming is expected to be widely applied. In this case, a SL capable UE may also experience beam failures during its SL transmission or reception. Without a beam failure recovery (BFR) procedure, it will not be feasible for the UE to continue SL transmission or reception, since the UE is blocked on the current serving beam and a SL radio link failure (RLF) is likely to be triggered. It is expected that a SL UE can detect a BF following the same detection mechanism as in Uu. In other words, the UE declares BF for the current serving beam when the number of beam failure instance indications from the physical layer reaches a configured threshold before a configured timer expires. Upon detection of the BF, the UE (from the SL reception perspective) would need to indicate to its peer UE (as the TX UE) of the BF, so that its peer UE can change to a different serving beam for subsequent transmission towards the UE.

While different from Uu, SL radio bearer (RB) is directional, for a UE pair including UE1 and UE2, for either direction, the TX UE is responsible to provide configuration (e.g., RB configuration, or CSI-RS configuration) to the RX UE. In this case, for the direction from UE1 to UE2, UE1 configures SL CSI-RS resources, based on which UE2 measures SL CSI-RS and provides a SL CSI report to UE1. Vice versa, for the direction from UE2 to UE1, it is UE2 that is responsible for configuring the SL CSI-RS resources to UE1 based on which UE1 measures the SL CSI-RS and provides a SL CSI report to UE2. Transmissions in both directions are executed independently. CSI-RS is expected to be one of beam monitoring RS types. The issues described below are also valid if other RS types (e.g., SL SSB) are applied for SL beam monitoring.

FIGS. 1, 2 and 3 illustrate a scenario that can be addressed using one or more of the techniques described herein. FIG. 1 shows two UEs, UE1 and UE2, and a simplified representation of the various beams that the UEs can use to transmit signals. Each UE is shown with four transmitting beams, Tx B1, Tx B2, Tx B3 and Tx B4. Initially, in FIG. 1(a), UE1 is using serving beam Tx B2 to transmit to UE2, and UE2 is using serving beam Tx B4 to transmit to UE1. However, in FIG. 1(b) the orientation of UE 1 has changed (e.g. rotated 90° so serving beam Tx B2 is no longer directed towards UE2. As a result, UE2 will experience beam failure (BF) as it is no able to receive the transmissions that UE1 sends via Tx B2. UE2's serving Tx beam (Tx B4) still points to UE1. BF in the direction UE2 to UE1 may still occur, depending on UE1's reception/receive beam.

FIG. 2(a) shows the same initial arrangement as FIG. 1(a), but in FIG. 2(b), both UE1 and UE2 have changed orientation by 90°. After this change in orientations, the serving beams of both UE1 and UE2 are pointing in the wrong directions, and both UEs will experience BF.

FIG. 3 is a simplified signalling diagram illustrating the establishment of signalling and occurrence of beam failures for UE1 and UE2 according to FIG. 2. Thus, FIG. 3 shows the establishment of communications between the UEs, which includes initial beam selection and establishing a PC5 link, and then subsequent transmissions from UE1 to UE2, and from UE2 to UE1. At some time point, UE2 detects a BF for transmissions from UE1, and at another time point (which can be before, after, or generally at the same time as UE2 detecting BF) UE1 detects a BF for transmissions from UE2.

For SL BFR, two issues have been observed:
Issue 1: BF can be detected by UE1 or UE2 via monitoring the reception of beam failure detection reference signals (RS). Whenever BF is detected by one UE (e.g., UE2) for the beam from UE1 to UE2, UE2 needs to inform UE1 of the BF on the reverse direction. It is unclear how UE2 should do this, e.g. it is unclear which beam in the direction from UE2 to UE1 that UE2 should use to transmit the BFR message, since the current serving beam on the reverse direction may also likely fail soon, as illustrated in FIG. 3.

Issue 2: Whenever BF is detected by one UE (e.g., UE2), UE2 needs to inform UE1 of the BF on the reverse direction. It is unclear how UE2 should signal the BFR to UE1, e.g., in terms of the signalling content and format.

Certain aspects of the disclosure and their embodiments may provide solutions to these or other challenges.

In particular, the techniques described herein provide one or more mechanisms for a UE (referred to as “UE1”, “RX UE”, a “first UE” or a “first wireless device”) to transmit beam failure recovery (BFR) signalling to its peer UE (referred to as “UE2”, “TX UE”, a “second UE” or a “second wireless device”) using a proper beam on the reverse direction when the UE has detected the BF on one or multiple serving beams from its peer UE. The proposed mechanisms enable the UE to report the BFR to its peer UE, even if the BF is also detected by its peer UE on the reverse direction.

In an example of the techniques described herein, if beam failure is detected by the first UE (UE1), UE1 performs one or more of the following steps:
Step 1: UE1 attempts to send the BFR signalling to UE2 using the current serving TX beam (from UE1 to UE2). UE1 may start a timer (e.g., Timer 1) with a duration which allows UE1 to be able to complete transmission of the BFR signalling if the current serving TX beam is still in good condition. While Timer 1 is running, UE1 may perform retransmissions of the BFR signalling if UE1 receives a negative acknowledgement or no acknowledgement of the transmission of BFR signalling from UE2 (e.g., a second timer expires while no acknowledgement is received—the second timer has shorter duration than Timer 1).

While Timer 1 is running, UE1 stops Timer 1 if UE1 receives a positive acknowledgement from UE2 indicating that UE2 has received the BFR signalling successfully.

Step 2: If UE1 doesn't manage to send the BFR signalling to UE2 using the current serving TX beam successfully (e.g., Timer 1 is expired, while UE1 cannot receive a positive acknowledgement from UE2 indicating the BFR has been received), UE1 chooses a different TX beam for the BFR signalling for the direction from UE1 to UE2.

Upon reception of the BFR signalling, the peer UE (UE2) would determine to use a different TX beam from the one on which UE1 has detected the BF.

In a variation to the above solution, in step 1 the UE1 can send the BFR signalling for UE2 to a base station (e.g. gNB). The base station can then send the BFR signalling to UE2.

Thus, the techniques described herein provide steps for the RX UE to take to transmit BFR signalling to the TX UE upon detection of the BF. Some embodiments provide that the RX UE may trigger RX beam sweeping to identify an appropriate beam or beams to use. Some embodiments provide that the BFR signalling can be sent via a beam with a different (e.g. wider) width that the beam that has failed. Some embodiments provide techniques for the TX UE (UE2) to detect and declare SL BF from the TX UE perspective.

According to a first aspect, there is provided a method performed by a first wireless device. The first wireless device is configured to send communications to a second wireless device via a first configured beam and receive communications from the second wireless device via a second configured beam. The method comprises transmitting beam failure recovery, BFR, signalling to the second wireless device or a network node if beam failure is detected for the second configured beam. Transmitting the BFR signalling to the second wireless device comprises transmitting the BFR signalling via the first configured beam and/or via at least one different beam.

According to a second aspect, there is provided a method performed by a second wireless device. The second wireless device is configured to receive communications from a first wireless device via a first configured beam and to send communications to the first wireless device via a second configured beam. The method comprises receiving beam failure recovery, BFR, signalling. The BFR signalling is received from the first wireless device via the first configured beam and/or via at least one different beam, or the BFR signalling is received from a network node.

According to a third aspect, there is provided a method performed by a network node. The method comprises receiving beam failure recovery, BFR, signalling from a first wireless device. The BFR signalling relates to a beam from a second wireless device to the first wireless device. The network node sends the BFR signalling to the second wireless device.

According to a fourth aspect, there is provided a computer program product comprising a computer readable medium having computer readable code embodied therein, the computer readable code being configured such that, on execution by a suitable computer or processor, the computer or processor is caused to perform the method according to the first aspect, the second aspect or the third aspect, or any embodiments thereof.

According to a fifth aspect, there is provided a wireless device configured to perform the method according to the first aspect, the second aspect, or any embodiments thereof.

According to a sixth aspect, there is provided a wireless device comprising a processor and a memory, said memory containing instructions executable by said processor whereby said wireless device is operative to perform the method according to the first aspect, the second aspect, or any embodiments thereof.

According to a seventh aspect, there is provided a network node configured to perform the method according to the third aspect or any embodiment thereof.

According to an eighth aspect, there is provided a network node comprising a processor and a memory, said memory containing instructions executable by said processor whereby said network node is operative to perform the method according to the third aspect or any embodiment thereof.

Certain embodiments may provide one or more of the following technical advantage(s). In particular, the proposed mechanism(s) enable a SL UE to indicate a detected SL BF event to the peer UE. Embodiments provide that the UE is able to quickly switch to a different candidate beam for further SL transmission or reception so that SL transmission/reception is not blocked or prevented by any BF.

### BRIEF DESCRIPTION OF THE DRAWINGS

Some of the embodiments contemplated herein will now be described more fully with reference to the accompanying drawings, in which:

FIG. 1 is a simplified representation of various beams that two UEs can use to transmit signals;

FIG. 2 is another simplified representation of various beams that two UEs can use to transmit signals;

FIG. 3 is a signalling diagram illustrating the occurrence of beam failures for two UEs;

FIG. 4 is a simplified signalling diagram illustrating embodiments of the techniques described herein;

FIG. 5 illustrates use of beams having different widths;

FIG. 6 is an example of transmitting BFR signalling in a MAC CE format;

FIG. 7 is another example of transmitting BFR signalling in a MAC CE format;

FIG. 8 is a flow chart illustrating a method of operating a first wireless device according to various embodiments;

FIG. 9 is a flow chart illustrating a method of operating a second wireless device according to various embodiments;

FIG. 10 is a flow chart illustrating a method of operating a network node according to various embodiments;

FIG. 11 shows a UE in accordance with some embodiments;

FIG. 12 shows a network node in accordance with some embodiments; and

FIG. 13 is a block diagram illustrating a virtualization environment in which functions implemented by some embodiments may be virtualized.

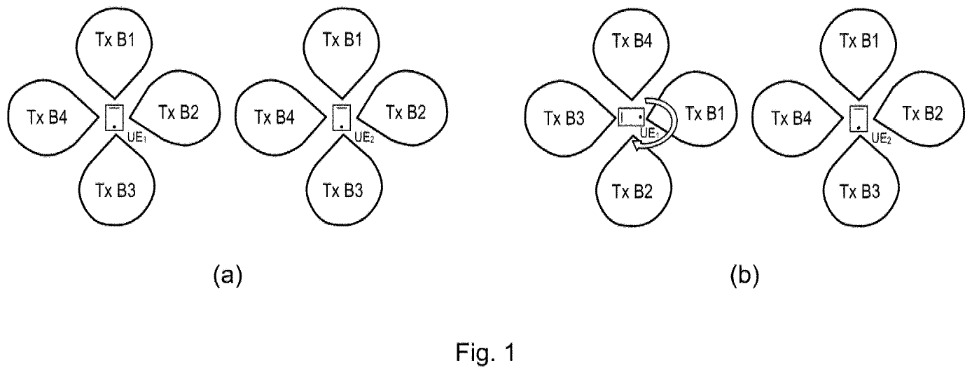

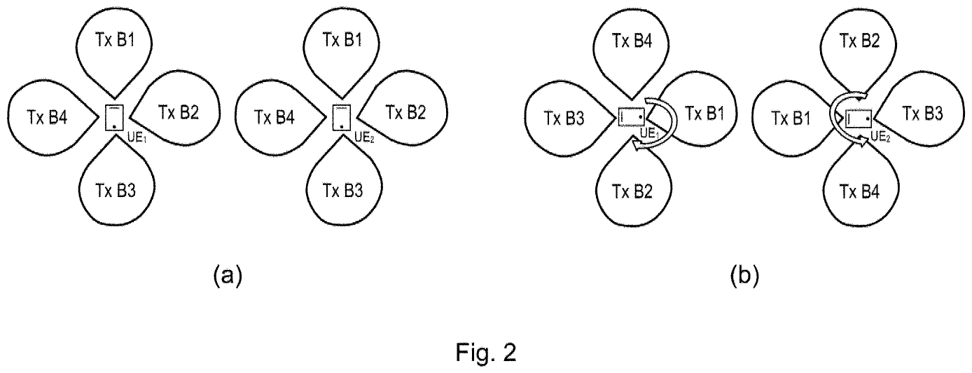

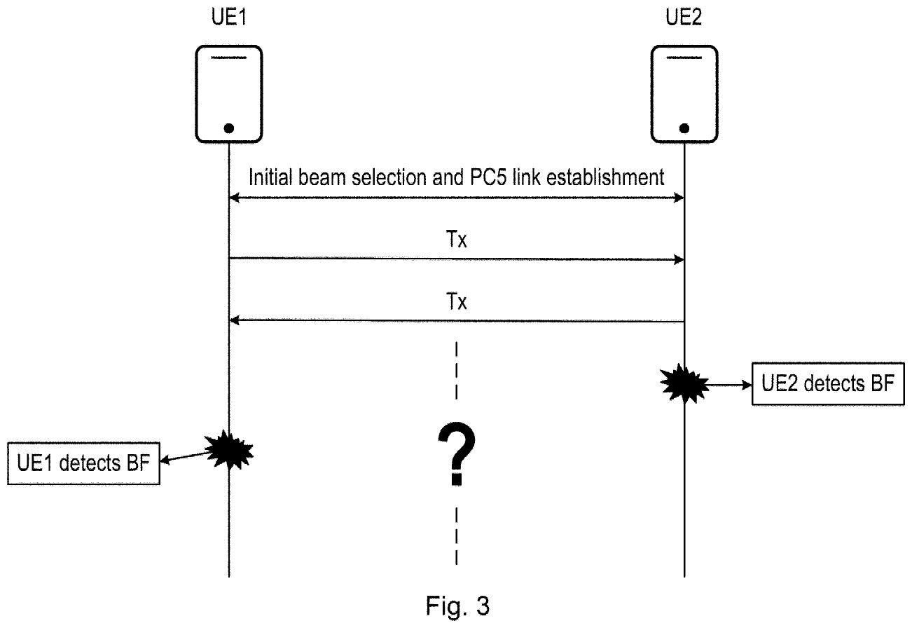

### DETAILED DESCRIPTION

Some of the embodiments contemplated herein will now be described more fully with reference to the accompanying drawings. Embodiments are provided by way of example to convey the scope of the subject matter to those skilled in the art.

While the techniques presented herein are described with reference to the NR radio access technology (RAT), it will be appreciated that the techniques can also be applied to the LTE RAT, and any other RAT enabling direct transmission between two (or more) nearby devices.

The methods described in the following embodiments are applicable to SL UEs with beamforming-based SL transmission or reception with any cast type including unicast, groupcast or broadcast.

In the embodiments, SL CSI-RS is assumed to be the RS for at least one of the following purposes:
Beam management (e.g., beam selection and reselection), e.g., UE measures CSI-RS configured by the peer UE and provides a CSI report containing measurements of CSI-RS to the peer UE;
Beam failure detection; and
Determining/identifying candidate beams.

However, unless otherwise indicated, the embodiments described herein are not limited by the above assumptions. For example, any other type of RS (e.g., SL SSB) or means to detect beam failure and/or candidate beams can be used.

The embodiments below are described in the context of a UE pair, e.g., UE1 and UE2 which are involved in a SL unicast transmission. It is assumed that the TX UE determines the TX beam in one direction. In other words, for the direction from UE1 to UE2, UE1 determines its TX beam based on the beam measurement results provided by UE2 (e.g., SL CSI reporting). Vice versa, for the direction from UE2 to UE1, UE2 determines its TX beam based on the beam measurement results provided by UE1 (e.g., SL CSI reporting). The embodiments are not limited by this assumption. The embodiments are equally applicable in case of other options on how to determine the TX beam are used. In other options, a beam correspondence is configured for UE1 or UE2 between a RX beam in one direction and a TX beam in the other direction. In this way, whenever the UE has determined a RX beam in one direction, the UE can determine a TX beam in the other direction according to the beam correspondence.

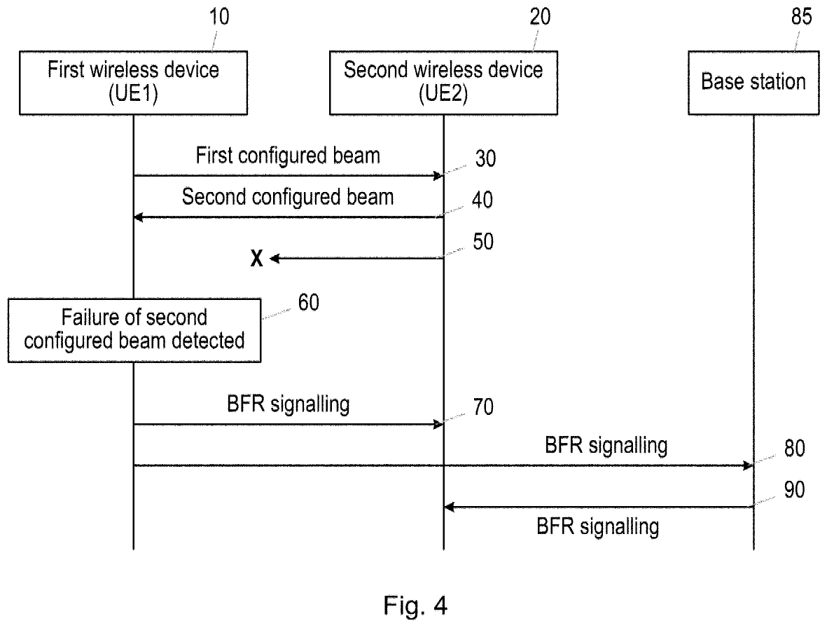

FIG. 4 is a simplified signalling diagram illustrating embodiments of the techniques described herein. FIG. 4 shows the signalling between a first wireless device/UE1 10 and a second wireless device/UE2 20. The first wireless device 10 transmits signals to the second wireless device 20 via a first configured beam (shown as signal 30). The second wireless device 20 transmits signals to the first wireless device 10 via a second configured beam (shown as signal 40).

A failure 50 occurs with respect to the second configured beam 40, which means that the first wireless device 10 is not able to receive transmissions from the second wireless device 20. The first wireless device 10 detects the failure in step 60.

According to embodiments of the techniques described herein, the first wireless device 10 sends BFR signalling 70 to the second wireless device 20. This BFR signalling 70 can be sent via the first configured beam 30, and/or via a different beam. Alternatively, or in addition, as shown by signal 80, the first wireless device 10 can send BFR signalling 80 to a base station 85 (e.g. gNB), and the base station 85 can send the BFR signalling 90 to the second wireless device 20. In some embodiments, if the sending of the BFR signalling 70 from UE1 10 to UE2 20 fails, UE1 10 can then send the BFR signalling 80 to the base station 85.

In some embodiments, UE1 10 or UE2 20 can detect or declare the SL BF when the number of SL beam failure instance indications from the physical layer reaches a configured threshold before a configured timer expires.

For UE1 10 or UE2 20, a set of RS resources (e.g., SL CSI-RS resources) can be configured for beam failure detection purposes. Meanwhile, another set of RS resources (e.g., SL CSI-RS resources) may be configured for the UE to use to determine candidate beams.

The physical layer in the UE can provide an indication (i.e., SL beam failure instance) to higher layers when the radio link quality for all corresponding RS resource configurations in the set (e.g., a set of SL CSI-RS resources) that the UE uses to assess the radio link quality is worse than a threshold (e.g., Q_{out,LR SL CSI-RS}).

Upon request from higher layers (e.g., when the BF is detected), the UE1 10 can provide, to higher layers, the RS indices from the set of RS resources which are configured for determining candidate beams and the corresponding measurements (e.g., L1-RSRP) that are larger than or equal to a threshold (e.g., Q_{in,LR SL CSI-RS}).

Although the following discussion refers to actions by UE1 in response to detecting the beam failure on the beam from UE2 to UE1, and actions by UE2 in response to receiving BFR signalling from UE1, it will be appreciated that UE2 can detect a beam failure on the beam from UE1 to UE2 and perform corresponding actions to send BFR signalling to UE1, and UE1 can respond to that BFR signalling in a corresponding way.

Thus, in some embodiments, UE1 10, which is capable of beamforming based SL transmission or reception, monitors BF instances between the UE and its peer UE (e.g., UE2 20). Upon detection of a BF 50 (i.e., the current serving beam from UE2 20 to UE1 10 has failed), UE1 10 performs at least one of the following steps to report the BF to UE2 20. Meanwhile, UE2 20 may also monitor BF instances on the direction from UE1 10 to UE2 20.

Step 1: UE1 10 can attempt to send the BFR signalling 70 to UE2 20 using the current serving TX beam (e.g. using the first configured beam 30) on the direction from UE1 10 to UE2 20. In this step, UE1 10 is able to determine if the current serving TX beam 30 on the direction from UE1 10 to UE2 20 is still available to use when BF 50 is detected in the direction from UE2 20 to UE1 10 by UE1 10.

UE1 10 may apply or use at least one of the following options to determine/check if the current serving TX beam 30 on the direction from UE1 10 to UE2 20 is available.

Option 1: In this option, UE1 10 may start a timer (e.g., Timer 1) with a duration which allows UE1 10 to be able to complete transmission of the BFR signalling 70 if the current serving TX beam 30 is still in good condition. While Timer 1 is running, UE1 10 may perform retransmissions of the BFR signalling 70 if UE1 10 receives a negative acknowledgement or no acknowledgement of the transmission of BFR signalling 70 from UE2 20 (e.g., a second timer expires while no acknowledgement is received-here the second timer has a shorter duration than Timer 1).

While Timer 1 is running, UE1 10 can stop Timer 1 if UE1 10 receives a positive acknowledgement from UE2 20 indicating that UE2 20 has received the BFR signalling 70 successfully.

Option 2: a maximum number of transmission and retransmission attempts is configured for transmission of the BFR signalling 70 using the current serving beam 30 for UE1 10 in the direction from UE1 10 to UE2 20.

If the BFR signalling 70 is signalled using a Layer 1 (L1) signalling (e.g., Sidelink Control Information (SCI)), the transmission occasions/attempts of the L1 signalling can be counted by UE1 10.

If the BFR signalling 70 is signalled using a MAC CE, the HARQ transmission and retransmissions can be counted by UE1 10.

If the BFR signalling is signalled using an upper layer signalling protocol (e.g., RRC or a control Protocol Data Unit (PDU)), upper layer transmission and retransmissions can be counted by UE1 10.

In some embodiments, UE1 10 can set/reset the counter of transmission and retransmission attempts for the BFR signalling 70 to be 0 every time that the BF 50 is detected by UE1 10 (e.g., the number of SL beam failure instance indications from the physical layer reaches a configured threshold before a configured timer expires).

In some embodiments, if the counter of transmission and transmission attempts for the BFR signalling 70 has reached the maximum number while UE1 10 fails to transmit the BFR signalling 70 to UE2 20, UE1 10 can determine that the current serving beam is no longer available, and therefore UE1 10 uses a different beam to continue transmitting the BFR signalling 70 instead. That is, UE1 10 can use a different beam to the first configured beam 30.

In some embodiments, as a further step UE1 10 can also monitor failure instances triggered by other transmissions (e.g. other than the BFR signalling transmissions) from UE1 10 towards UE2 20. If other transmissions indicate that the current serving beam from UE1 10 to UE2 20 may be not available, the UE1 can operate according to Step 2 below.

For any of the above options, if UE1 10 fails to successfully transmit the BFR signalling 70 using the current serving beam on the direction from UE1 10 to UE2 20, the UE1 can operate according to Step 2.

Step 2: If UE1 10 is not able to successfully send the BFR signalling 70 to UE2 20 using the current serving TX beam (i.e. the first configured beam 30) successfully in Step 1, UE1 10 can select a different TX beam to use for the BFR signalling 70 in the direction from UE1 10 to UE2 20. In some embodiments, the different beam can be selected according to one of the following options:
Option 1: a TX beam can be selected which corresponds to the RX beam that UE1 10 uses for monitoring the reception from UE2 20. For this option UE1 10 needs to support beam correspondence.
Option 2: a TX beam can be selected according to the latest SL CSI measurements received from UE2 20. This beam could be one of a set of candidate beams having a radio channel quality (e.g., Reference Signal Received Power (RSRP) of the associated CSI-RS resources measured by UE2 20) higher than a threshold.

In one example, UE1 10 can select the strongest beam (in terms of radio channel quality, e.g., RSRP) among the beams which are non-serving and have a radio channel quality (e.g., RSRP) above the threshold.

In another example, UE1 10 can randomly select any one of the beams which are non-serving and have radio channel quality (e.g., RSRP) above the threshold.

In another example, UE1 10 can select the strongest beam (in terms of radio channel quality, e.g., RSRP) among the beams which are non-serving, regardless of whether the selected beam has a radio channel quality above or lower than the threshold. This can ensure UE1 selects at least one beam if none of the non-serving beams has a radio channel quality above the threshold.

In yet another example, UE1 10 can select the best beam according to a beam sweeping among the beams which have a radio quality above a threshold, or among all beams except the current serving beam.

Once selected, UE1 10 uses the selected TX beam to transmit the BFR signalling 70.

Optionally, as a further step, UE1 10 may repeat the same TX beam (i.e., perform P3 procedure) for a configured time period, or for a configured number of times, in order to reach UE2 20, since UE2 20 may be not aware when and whether UE1 10 has detected BF 50. In such a case, UE2 20 may still monitor the current serving beam and be prepared to receive transmissions from UE1 10. The time period for UE1 10 to repeat the same TX beam should cover at least the uncertain period during which UE2 20 may still monitor the current serving beam.

As a possible further step, the TX UE 10 may perform power ramping when doing repeated transmissions of the BFR signalling according to any of the above schemes or options. That is, UE1 10 can increase the power used to transmit the BFR signalling with each repeated transmission.

As another further step, for each alternative beam selected by UE1 10 in Step 2 for transmission of the BFR signalling 70, UE1 10 may perform attempts to transmit the BFR signalling to UE2 20 for a configured maximum number of times, or for a configured time period. If, after this number or times or after the configured time period, the transmission of the BFR signalling has not been successful, UE1 10 can select another different beam using any of the same options as described in Step 2.

As a further step, UE1 10 may be configured with another timer indicating a maximum time period during which UE1 10 can attempt to transmit the BFR signalling 70 to UE2 20 in Step 1 and Step 2. Alternatively, UE1 10 may be configured with a maximum number of transmission attempts for UE1 10 to transmit the BFR signalling 70 to UE2 20 in Step 1 and Step 2. If UE1 10 fails to transmit the BFR signalling 70 to UE2 20 in the two steps, UE1 10 may declare a radio link failure (RLF) on the link between UE1 10 and UE2 20. UE1 10 would then stop transmissions to UE2 20 using the failed link.

An alternative embodiment to Step 1 as described above is also possible. In particular, on detecting BF 50, UE1 10 can attempt to send the BFR signalling 70 to UE2 20 using a different beam to the current serving TX beam (e.g. using a different beam to the first configured beam 30). Effectively, in this embodiment UE1 10 omits Step 1 and proceeds straight to Step 2 on detecting a BF.

In another alternative embodiment, on detecting BF 50, UE1 10 can attempt to send the BFR signalling 70 to UE2 20 using a plurality of beams. The plurality of beams can include the first configured beam 30 and at least one different beam. In this case, UE1 10 effectively performs Steps 1 and 2 together. Alternatively, the plurality of beams can comprise a plurality of beams other than the first configured beam 30. In this case, UE1 10 effectively performs Step 2 using multiple different beams.

In some embodiments, a UE, for example UE1 10 and/or UE2 20, that is capable of beamforming-based SL transmission or reception, may perform RX beam sweeping in order for the UE to be prepared to receive any transmission (including the BFR signalling 70) from its peer UE (e.g., UE1 or UE2). This beam sweeping may be performed at any time, e.g. before any BF is detected, and/or after a BF is detected. In certain embodiments, beam sweeping can be performed if one of the below conditions is met:
1) A periodic timer has expired. The timer value could be different depending on the services/applications that are being served. For services/applications with critical QoS requirements (e.g., requiring a short delay), a short timer value can be applied. For services/applications with non-critical QoS requirements (e.g., requiring a long delay), a large timer value can be applied.
2) The UE has detected a BF on the direction towards the UE from the peer UE, i.e., the current serving beam from the peer UE to the UE has failed.
3) The UE has not received any transmission from the peer UE on the current serving beam(s) over a configured time period (which can also/alternatively mean that the UE has not received any RLC acknowledgement(s) have been received for the configured time period).
   The UE may monitor multiple serving beams from the peer UE, with each serving beam serving a specific type of transmission from the peer UE to the UE.
      E.g., UE1 can monitor beam 1 for control channel/signalling, while UE1 can monitor beam 2 for data channel/signalling.
      E.g., UE1 can monitor beam 1 for Physical Sidelink Shared Channel (PSSCH), while monitoring beam 2 for Physical Sidelink Control Channel (PSCCH), and monitoring beam 3 for Physical Sidelink Feedback Channel (PSFCH).
   The UE may perform RX beam sweeping if there are no transmissions on a specific serving beam over a configured time period.
   The UE may perform RX beam sweeping if there are no transmissions on any serving beam over a configured time period.
   The UE may perform RX beam sweeping if there are no transmissions on X serving beams over a configured time period.

The maximum number of different beams in the RX beam sweep can be configured. In one example, this is configured to be the same as the number of repetitions used for transmissions on any Tx beam by the TX UE. In this way the RX UE is guaranteed to sweep through all reception beams for each TX beam used by the TX UE.
4) The UE has received too few transmissions from the peer UE on the current serving beams over a configured time period, e.g., the number of received transmissions over a time period T is less than N.
The UE may perform RX beam sweeping if there are too few transmissions on a specific serving beam over a configured time period.
The UE may perform RX beam sweeping if there are too few transmissions on any serving beam over a configured time period.
   The UE may perform RX beam sweeping if there are too few transmissions on X serving beams over a configured time period.

According to the above embodiments, upon UE1 10 detecting BF over a narrow beam from UE2 20 to UE1 10, UE1 10 will send BFR signalling 70 to UE2 20 in the reverse direction (i.e., from UE1 10 to UE2 20). In some embodiments, UE1 10 may send the BFR signalling 70 via a beam that has the same width as the beam from UE2 20 to UE1 10. However, in alternative embodiments, UE1 10 may decide to use a wide(r) beam for the transmission of the BFR signalling 70 in the direction from UE1 10 to UE2 20, on the assumption that UE2 20 may also detect the BF for the direction from UE1 10 to UE2 20 soon. The wide(r) beam may be the current serving beam, or a different beam from the current serving beam (e.g., where the current serving beam is a narrow beam). UE1 10 may have to wait for specific time occasions when a wide beam is configured or is allowed to be used. Those specific time occasions can be known to both UE1 10 and UE2 20. On those specific time occasions, UE1 10 can use a wide TX beam to transmit the BFR signalling 70 towards UE2 20, and meanwhile UE2 20 can be also prepared to use a wide RX beam for the reception of signals from UE1 10. In some embodiments, UE1 10 may first attempt to use a narrow beam to transmit the BFR signalling 70 to UE2 20, and after a configured time period or after a configured number of attempts to transmit the BFR signalling 70 to UE2 20 successfully using the narrow beam, UE1 10 can switch to using a wide beam to transmit the BFR signalling 70 to UE2 20 instead.

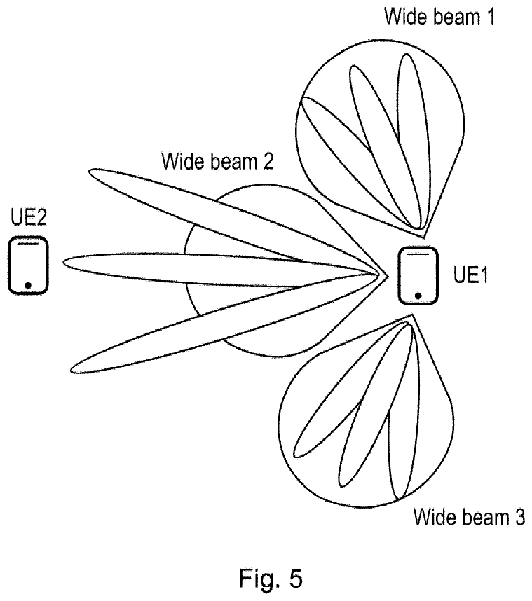

In some embodiments, UE1 10 and UE2 20 can perform the initial access and connection establishment via a wide beam, and subsequently perform the selection of a narrow beam within the selected wide beam. For example, as shown in FIG. 5, Wide beam 2 can be chosen by UE1 for connection establishment, and in addition, UE1 can choose one of the three narrow beams within Wide beam 2 to perform data transmission.

In some embodiments, for UE1 10 to identify that the narrow beams are associated, or are within a certain wide beam, there could be an implicit or explicit relationship between the narrow and wide beams. In the case of an explicit relationship, the narrow beam transmissions can include, for example, the beam identity (ID) of the associated wide beam. In the case of an implicit relationship, the timing of the narrow beam transmissions could take place after the transmission of the associated wide beam. For example, in a 14-symbol slot and with 3 narrow beams within one wide beam, if the wide beam is transmitted on symbol 2, the narrow beams could be transmitted on symbols 3, 4 and 5.

In some embodiments, UE1 10 and UE2 20 can apply through an appropriate reference signal configuration to associate one wide beam and one or multiple narrow beams in each direction. In an example, a reference signal can be configured to be associated with one wide beam and one or multiple narrow beams. When the UE-measured radio quality (e.g., RSRP, Signal to Interference +Noise Ratio (SINR), Reference Signal Received Quality (RSRQ), etc.) of the reference signal is above a configured threshold, the UE can use the associated wide beam or narrow beams for transmissions. Whether the UE shall first attempt to use the wide beam or narrow beams may be up to the configuration of the UE. In one example, the UE first attempts to use narrow beams, and if the transmission of the BFR signalling using the narrow beams fails, the UE can use a wide(r) beam for the subsequent transmission of the BFR signalling instead. In another example, the UE can first attempt to use the wide beam, and if the transmission using the wide beam fails, the UE can switch to using narrow beams. In one example, the UE can be configured with a threshold value for radio quality, and the UE uses narrow beams only when the measured radio quality of the reference signal is above the threshold, and otherwise the UE uses wide beam for transmissions instead.

In other embodiments, the UE can also choose to use SSB measurements to initially chose another wide beam first. Then, based on the chosen wide beam, the narrow beam can be further chosen based on CSI-RS measurements. Depending on the measurements, early BF recovery can be triggered for either the wide beam or the narrow beam.

The BFR signalling sent by UE1 10 according to the above embodiments can include any suitable information to recover communications with UE2 20.

The BFR signalling can comprise any one or more of the following types of information:
Information identifying the beam (the second configured beam 40) where the failure event has been detected, e.g. an index for the failed beam;
Information identifying a carrier (e.g. the SL carrier) and/or frequency of the failed beam (the second configured beam 40);
Information identifying UE1, e.g. a UE ID/index;
Information indicating a cause of failure for the beam (e.g. indicating that the failure has been triggered due to BF);
Information relating to one or more candidate beams that can be used for further communications from UE2 to UE1, e.g. indices of one or multiple configured RS resources for candidate beams (i.e., candidate TX beams from UE2 to UE1) which have sufficiently good radio channel quality according to UE1's measurements to the configured RS resources (e.g., the RS resources whose RSRP is above a configured threshold)

UE1 10 can send the BFR signalling 70 using, or in, at least one of the following types of signalling:
PC5-RRC signalling;
MAC CE;
L1 signalling, e.g., SCI.

When using PC5-RRC signalling, UE1 10 may use UEAssistanceInformationSidelink signalling. The original purpose of this signalling is for a UE to inform its peer UE of the sidelink discontinuous reception (DRX) assistance information used to determine the sidelink DRX configuration for unicast communication. This signalling can be extended to include the content of the BFR signalling described herein.

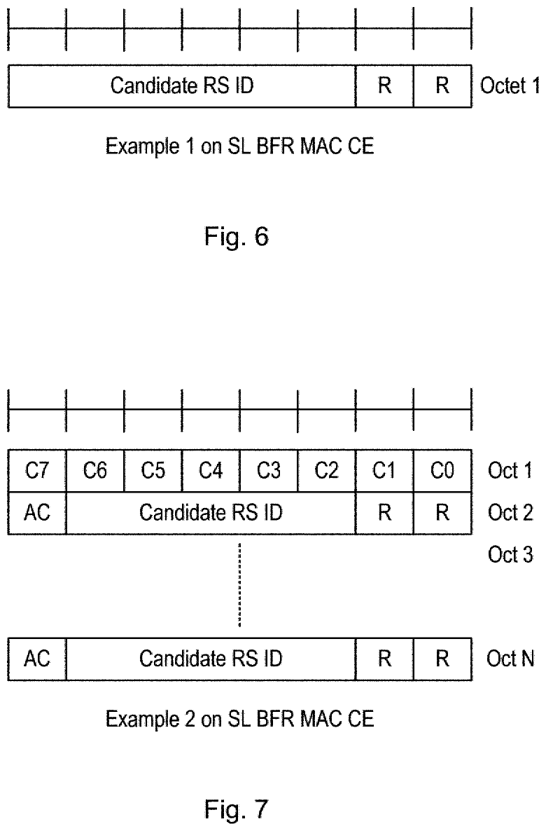

When using a MAC CE-based approach for the BFR signalling, a MAC CE (e.g., named as SL BFR MAC CE) can convey the content of the BFR signalling. The MAC CE type can be identified by a MAC subheader with Logical Channel ID (LCID). In addition, one bit may be defined in the MAC subheader indicating whether the octet containing a candidate RS ID is present or absent. In some cases, the octet containing candidate RS ID may be absent, in which case, upon receiving the MAC CE, UE2 20 can determine a TX beam by itself, or based on previous CSI reports received from UE1 10. Two examples of the MAC CE format are shown in FIGS. 6 and 7. FIG. 6 shows an example of a SL BFR MAC CE containing only one candidate RS ID in case of a single SL carrier. FIG. 7 shows an example of a SL BFR MAC CE in the event that there are multiple single SL carriers. In FIG. 7, “AC” indicates if a candidate RS ID is present in that particular octet, and each row of the MAC CE corresponds to respective SL carriers whose indicator bit is ‘1’ in the first octet.

When the BFR signalling is sent using MAC CE, the priority of the MAC CE could be set to a fixed value in any of the following ways:
The highest priority transmission over SL, i.e., higher priority than data from SCCH.
Lower priority than data from SCCH while higher priority than other SL MAC CE.
The same priority as SL CSI Reporting MAC CE.

When using the L1 signalling based approach, L1 signalling (e.g., SCI) can contain the BFR signalling. In an example, a new format SCI may be used to carry the BFR signalling. The SCI signalling may be a standalone SCI, i.e., transmitted separately to PSSCH data. Alternatively, the SCI signalling may be transmitted together with PSSCH data. The SCI signalling may be carried on PSCCH or PSSCH, using predefined/preconfigured resources, which may be in a resource pool which is configured for BFR signalling.

As noted above, in some embodiments UE1 10 transmits BFR signalling to a base station (e.g. gNB) 85. UE1 can do this as an alternative to sending the BFR signalling to UE2 20 via the first configured beam 30 and/or a different beam, or UE1 can do this if transmission of the BFR signalling via the first configured beam 30 and/or another beam fails. The base station (gNB) 85 can be a serving base station for UE1 and UE2. After receiving the BFR signalling 80 from UE1 10, the base station 85 sends or forwards the BFR signalling relating to the SL BF to UE2 20. Since the Uu link (the interface between a UE and gNB) is expected to be less susceptible to beam failures, the sending of BFR signalling via the base station 85 is expected to be more robust. If the Uu link is not subject to BF at the same time as the SL between the UEs, it may also be faster to send the BFR signalling via the base station 85 than reporting the BF over the SL, since there is no need for the UE(s) to determine the SL TX/RX beam to use for the BFR signalling.

In the embodiments where the BFR signalling can be sent via the base station 85 if transmission of the BFR signalling via the first configured beam 30 and/or another beam fails, the BFR signalling may be sent over the Uu to the base station 85 if the first N transmissions of the BFR signalling 70 on the serving beam (first configured beam 30) of UE1 10 fails. Alternatively, the BFR signalling may be sent over the Uu to the base station 85 if the first K transmissions on any selected serving beams of UE1 10 fail.

When the BFR signalling is transmitted over Uu to the base station 85, the BFR signalling may contain the same type(s) of information as described above. In particular embodiments, the BFR signalling is sent over Uu using a MAC CE or RRC signalling.

Some embodiments provide techniques for a UE to detect a beam failure of a beam from that UE to a peer UE (i.e. these techniques can allow UE1 10 to detect a failure on the first configured beam 30). In particular, UE1 10 can detect a failure on the first configured beam 30 when UE1 determines that one or more of the following has occurred:
M consecutive HARQ discontinuous transmission (DTX) for transmission to UE2 20 has been reached. The value of M can be (pre)configured. The value of M may be set smaller the value used to declare SL RLF.
N number of Radio Link Control (RLC) retransmissions has been performed towards UE2. The value of N can be (pre)configured. The value of N can be set smaller the value used to declare SL RLF.

When UE1 10 detects Tx beam failure towards a specific peer UE, it may perform one or more of the following:
Suspend transmission towards that specific UE until beam failure is recovered. This implies in logical channel prioritization (LCP) procedure it will only select destinations towards which the transmission is not suspended.
Send transmission towards that specific UE in several Tx beams (i.e., adopt Tx beam sweeping-the UE attempts transmission using different TX beams sequentially in time). During LCP, destination selection is only performed for transmission using the first Tx beam belonging to the Tx beam set. This may only be applied when PSFCH resource is WO configured (if not, the Tx UE may reselect another Tx pool with PSFCH resource configured). The sequence number of the Tx beam may be indicated in SCI (e.g., if 4 Tx beams are used to transmit a MAC PDU, 2 bits can be used to indicate whether the transmission uses the 1^{st}, 2^{nd}, 3^{rd} or 4^{th} Tx beam). Correspondingly the Rx UE (e.g. UE2 20) may perform one or more of the following:
   Perform soft combining of MAC PDU received from the same Tx UE that is sent in different Tx beams. For instance, the Rx UE may detect a MAC PDU which is sent from a Tx UE using the Jth Tx beam, and the UE may soft combine it with any of the previous detected MAC PDU sent from that Tx UE using the Kth Tx beam, where K<J and associated to the same (set of) PSFCH resource.
   Indicate the (best) Tx beam with which it has detected the transmission from the Tx UE, and optionally also indicate the measured SL-RSRP and/or whether the measured SL-RSRP is higher than a (pre)configured threshold.

In some embodiments, the Tx UE may stop Tx beam sweeping and transmit to the Rx UE using only the indicated best Tx beam if SL-RSRP of that beam is higher than the (pre)configured threshold.

In some embodiments, transmission suspension may be adopted when the transmission does not require low latency, otherwise transmitting using beam sweeping may be adopted.

The following relates to actions that can be taken by a UE in response to receiving BFR signalling indicating occurrence of SL BF for one or multiple beams. In particular, in response to UE2 20 receiving BFR signalling from UE1 10, UE2 may send signalling to UE1 informing UE1 of at least one of the following:
Confirmation of receipt of the BFR signalling from UE1;
The index of the SL carrier which the actions relate to;
Indices of one or multiple candidate beams which UE1 shall use for subsequent SL reception from UE2;
   In an option, the indices of the candidate beams are indicated;
   In another option, the indices of configured RS resources which are associated with the candidate beams are indicated;
Deactivation or de-configuration of the beam where UE1 has detected SL BF;
Reconfiguration of the SL beam between UE2 and UE1. Reconfiguration can comprise any of:
   configuring different resources/grants to UE1/UE2 to perform transmission or reception;
   configuring different transmission power to UE1/UE2 to perform transmission or reception;
   configuring different modulation and coding schemes (MCS) or MCS range to UE1/UE2 to perform transmission or reception;
Reconfiguration of the SL carrier. For example, adding or configuring a new SL bandwidth part (BWP) for the SL carrier, and meanwhile deactivating or de-configuring a SL BWP on which SL BF is detected;
Tear down the PC5-RRC connection with UE1; and
Reconfiguring or re-establishing the PC5-RRC connection with UE1.

UE2 20 can send the above signalling in response to the BFR signalling using any suitable signalling. For example, UE2 can send this signalling via PC5-RRC signalling, a MAC CE or L1 signalling on physical channels including e.g., PSSCH, PSCCH, PSFCH, etc.

After sending this signalling to UE1, UE2 will perform subsequent SL transmission towards UE1 using a different beam from the one on which UE1 detected the BF. The beam may be the same or different to the one(s) indicated by UE1 in the BFR signalling.

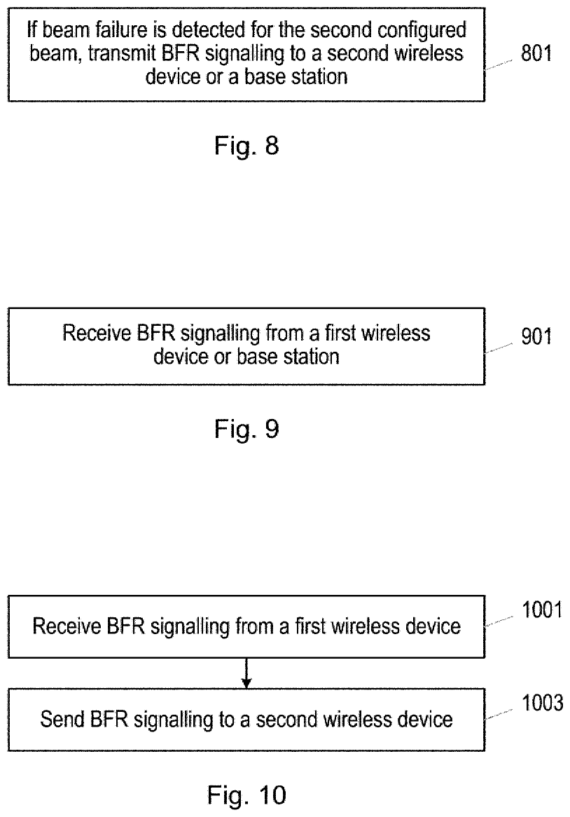

FIG. 8 is a flow chart illustrating a method of operating a wireless device according to various embodiments. The method in FIG. 8 relates to the operations of the first wireless device/UE1 10 described above. The first wireless device may perform the method in response to executing suitably formulated computer readable code. The computer readable code may be embodied or stored on a computer readable medium, such as a memory chip, optical disc, or other storage medium. The computer readable medium may be part of a computer program product.

The first wireless device 10 is configured to send communications to a second wireless device 20 via first configured beam 30 and receive communications from the second wireless device 20 via the second configured beam 40. If beam failure is detected for the second configured beam 40, then in step 801 the first wireless device 10 transmits BFR signalling 70, 80 to the second wireless device 20 or a network node 85 (e.g. a gNB). If the BFR signalling 70, 80 is transmitted to the second wireless device, it is transmitted via the first configured beam 30 and/or via at least one different beam.

The BFR signalling 70, 80 is for recovering communications from the second wireless device 20 to the first wireless device 10.

The BFR signalling may be transmitted in at least one of RRC signalling, a MAC CE, a control PDU of a protocol layer; and L1 signalling on a physical channel.

The BFR signalling comprises one or more of: information identifying the second configured beam 40; information identifying a carrier and/or frequency of the second configured beam 40; information identifying the first wireless device 10; information indicating a cause of failure for the second configured beam 40; information relating to one or more candidate beams that can be used for further communications from the second wireless device 20 to the first wireless device 10.

Some embodiments of step 801 comprise transmitting the BFR signalling to the second wireless device 20 via the first configured beam 30. The first wireless device 10 can transmit the BFR signalling to the second wireless device 20 via the first configured beam 30 one or more times until: a positive acknowledgement of the BFR signalling is received from the second wireless device 20; a timer expires; and/or until the BFR signalling has been transmitted to the second wireless device 20 via the first configured beam 30 a threshold number of times. In some embodiments, the first wireless device 10 can increase the power used to transmit the BFR signalling in subsequent transmissions of the BFR signalling. In some embodiments, if a positive acknowledgement of the BFR signalling is not received from the second wireless device 20, the first wireless device 10 can transmit the BFR signalling to the network node 85, or the first wireless device 10 can transmit the BFR signalling to the second wireless device 20 via a different beam.

In embodiments where the BFR signalling is transmitted to the second wireless device 20 via at least one different beam, the first wireless device 10 can transmit the BFR signalling via the different beam one or more times until: a positive acknowledgement of the BFR signalling is received from the second wireless device 20; a timer expires; and/or until the BFR signalling has been transmitted to the second wireless device 20 via the different beam a threshold number of times. In some embodiments, the first wireless device 10 can increase the power used to transmit the BFR signalling in subsequent transmissions of the BFR signalling. In some embodiments, if a positive acknowledgement of the BFR signalling transmitted via the different beam is not received from the second wireless device 20, the first wireless device 10 can transmit BFR signalling to the network node 85, or the first wireless device 10 can transmit the BFR signalling to the second wireless device 20 via another different beam.

In embodiments of step 801 in which the first wireless device 10 is to transmit the BFR signalling via a different beam, the method can further comprise the first wireless device 10 selecting a different beam to use to transmit the BFR signalling to the second wireless device 20. The different beam can be selected by any of: selecting the different beam as a beam in the direction of the second wireless device 20 corresponding to the first configured beam 30; selecting the different beam based on signal quality measurements; selecting the different beam based on signal quality measurements received from the second wireless device 20; selecting the different beam as a candidate beam that has a highest signal quality; selecting the different beam from a set of candidate beams whose signal quality is above a threshold; and performing beam sweeping of candidate beams.

The different beam via which the BFR signalling can be transmitted can be a wider beam than the first configured beam 30 and/or the second configured beam 40.

In some embodiments, the method further in the first wireless device 10 comprises detecting beam failure of the first configured beam 30 if one or more of: a threshold number of consecutive HARQ DTX has been reached for transmissions to the second wireless device 20 via the first configured beam; and a threshold number of upper layer retransmissions of communications to the second wireless device 20 via the first configured beam 30. The threshold number can be set to a value lower than a corresponding threshold number used to detect RLF.

In some embodiments, when beam failure is detected for the first configured beam 40, the first wireless device 10 can suspend transmission of communications to the second wireless device 20 via the first configured beam 40 until a beam to the second wireless device 20 is recovered; and/or transmit further communications to the second wireless device 20 via a plurality of beams until a single beam to the second wireless device 20 is recovered.

In some embodiments, the method can further comprise the first wireless device 10 receiving signalling from the second wireless device 20. This signalling can indicate one or more of: confirmation of receipt of the BFR signalling from the first wireless device 10; an identifier of a carrier or frequency to which the received signalling relates; information identifying one or more candidate beams that can be used by the first wireless device 10 for subsequent communications from the second wireless device 20; an indication that the second configured beam 40 is deactivated or deconfigured; an indication the second configured beam 40 is reconfigured; an indication a carrier or frequency used by the second configured beam 40 is reconfigured; and an indication that a RRC connection between the first wireless device 10 and the second wireless device 20 is to be taken down, reconfigured or re-established.

In some embodiments, step 801 can comprise the first wireless device 10 transmitting the BFR signalling to the second wireless device 20 (simultaneously, or at substantially the same time) via at least two of the first configured beam 30 and/or the at least one different beam. That is, the first wireless device 10 can transmit the BFR signalling via the first configured beam 30 and at least one different beam at the same time. Alternatively, the first wireless device 10 can transmit the BFR signalling via at least two different beams at the same time.

FIG. 9 is a flow chart illustrating a method of operating a wireless device according to various embodiments. The method in FIG. 9 relates to the operations of the second wireless device/UE2 20 described above. The second wireless device may perform the method in response to executing suitably formulated computer readable code. The computer readable code may be embodied or stored on a computer readable medium, such as a memory chip, optical disc, or other storage medium. The computer readable medium may be part of a computer program product.

The second wireless device 20 is configured to receive communications from a first wireless device 10 via first configured beam 30 and send communications to the first wireless device 10 via second configured beam 40.

In step 901 the second wireless device 20 receives BFR signalling 70, 90 from the first wireless device 10 or a network node 85 (e.g. a gNB). If the BFR signalling 70 is received from the first wireless device 10, it is received via the first configured beam 30 and/or via at least one different beam.

The second wireless device 20 may then perform BFR based on the received BFR signalling.

Thus, the BFR signalling may be received from the first wireless device 10 via the first configured beam 30. Alternatively, the BFR signalling may be received from the first wireless device 10 via at least one different beam. As another alternative, the BFR signalling may be received from the network node 85.

The BFR signalling 70, 90 is for recovering communications from the second wireless device 20 to the first wireless device 10.

The BFR signalling may be received in at least one of RRC signalling, a MAC CE, a control PDU of a protocol layer; and L1 signalling on a physical channel.

The BFR signalling comprises one or more of: information identifying the second configured beam 40; information identifying a carrier and/or frequency of the second configured beam 40; information identifying the first wireless device 10; information indicating a cause of failure for the second configured beam 40; information relating to one or more candidate beams that can be used for further communications from the second wireless device 20 to the first wireless device 10.

In some embodiments, the second wireless device 20 can send an acknowledgement of the BFR signalling to the first wireless device 10.

In some embodiments, the second wireless device 20 may be able to detect failure of the second configured beam 40. In particular, failure can be detected if one or more of: a threshold number of consecutive HARQ DTX has been reached for transmissions to the first wireless device 10 via the second configured beam 40; and a threshold number of upper layer retransmissions of communications to the first wireless device 10 via the second configured beam 40. The threshold number may be set to a value lower than a corresponding threshold number used to detect RLF.

The second wireless device 20 may send signalling to the first wireless device 10 indicating one or more of: confirmation of receipt of the BFR signalling from the first wireless device 10; an identifier of a carrier or frequency to which the transmitted signalling relates; information identifying one or more candidate beams that can be used by the first wireless device 10 for subsequent communications from the second wireless device 20; an indication that the second configured beam 40 is deactivated or deconfigured; an indication the second configured beam 40 is reconfigured; an indication a carrier or frequency used by the second configured beam 40 is reconfigured; and an indication that a RRC connection between the first wireless device 10 and the second wireless device 20 is to be taken down, reconfigured or re-established.

In some embodiments, the second wireless device 20 can perform beam sweeping to prepare for reception of communications from the first wireless device 10 via a different beam. Beam sweeping may be performed: periodically; after receiving the BFR signalling from the first wireless device 10; if the second wireless device 20 has not received communications from the first wireless device 10 for at least a threshold time period; or if the second wireless device 20 has received too few (i.e. has not received enough) communications from the first wireless device 10 for at least a threshold time period.

FIG. 10 is a flow chart illustrating a method of operating a network node according to various embodiments. The method in FIG. 10 relates to the operations of the network node/base station 85 described above. The network node may perform the method in response to executing suitably formulated computer readable code. The computer readable code may be embodied or stored on a computer readable medium, such as a memory chip, optical disc, or other storage medium. The computer readable medium may be part of a computer program product.

In step 1001, the network node 85 receives BFR signalling 80 from a first wireless device 10. The BFR signalling 80 relates to a beam from a second wireless device 20 to the first wireless device 10.

In step 1003, the network node 85 sends the BFR signalling 90 to the second wireless device 20.

The network node 85 can be a serving base station for the first wireless device 10 and/or the second wireless device 20.

The BFR signalling 80, 90 is for recovering communications from the second wireless device 20 to the first wireless device 10.

The BFR signalling may be received in at least one of RRC signalling and a MAC CE.

The BFR signalling comprises one or more of: information identifying the beam that the BFR signalling relates to; information identifying a carrier and/or frequency of the beam; information identifying the first wireless device 10; information indicating a cause of failure for the beam; information relating to one or more candidate beams that can be used for further communications from the second wireless device 20 to the first wireless device 10.

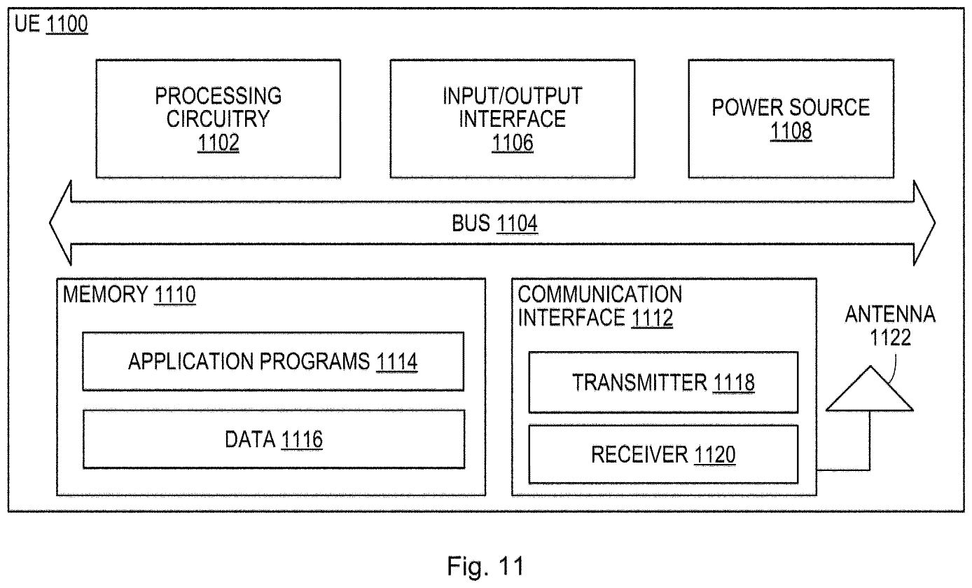

FIG. 11 shows a wireless device or UE 1100 in accordance with some embodiments. As used herein, a UE refers to a device capable, configured, arranged and/or operable to communicate wirelessly with network nodes and/or other UEs. Examples of a wireless device/UE include, but are not limited to, a smart phone, mobile phone, cell phone, voice over IP (VOIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A wireless device/UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g. a smart sprinkler controller). Alternatively, a UE may represent a device that is not intended for sale to, or operation by, an end user but which may be associated with or operated for the benefit of a user (e.g. a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g. in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs). The processing circuitry 1102 may be operable to provide, either alone or in conjunction with other UE 1100 components, such as the memory 1110, to provide UE 1100 functionality. For example, the processing circuitry 1102 may be configured to cause the UE 1102 to perform the methods as described with reference to FIGS. 8 and/or 9.

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g. a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g. an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a Universal Subscriber Identity Module (USIM) and/or integrated SIM (ISIM), other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g. another UE or a network node in an access network). Each transceiver may include a transmitter 1118 and/or a receiver 1120 appropriate to provide network communications (e.g. optical, electrical, frequency allocations, and so forth). Moreover, the transmitter 1118 and receiver 1120 may be coupled to one or more antennas (e.g. antenna 1122) and may share circuit components, software or firmware, or alternatively be implemented separately.

In some embodiments, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) or other Global Navigation Satellite System (GNSS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, NR, UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g. once every 15 minutes if it reports the sensed temperature), random (e.g. to even out the load from reporting from several sensors), in response to a triggering event (e.g. when moisture is detected an alert is sent), in response to a request (e.g. a user initiated request), or a continuous stream (e.g. a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an IoT device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

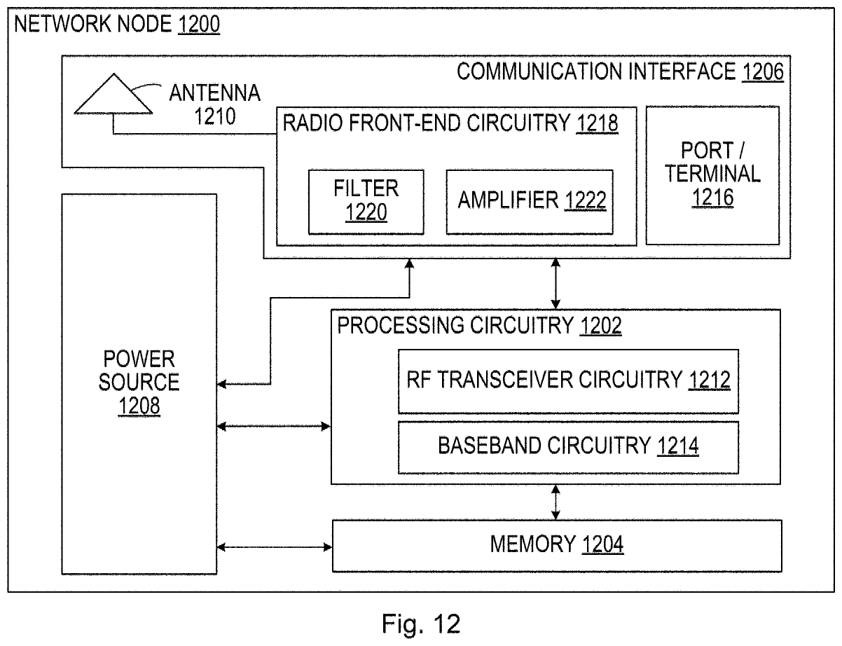

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access network nodes such as APs (e.g. radio access points), base stations (BSs) (e.g. radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g. Evolved Serving Mobile Location Centers (E-SMLCs)), and/or Minimization of Drive Tests (MDTs).

The network node 1200 includes processing circuitry 1202, a memory 1204, a communication interface 1206, and a power source 1208, and/or any other component, or any combination thereof. The network node 1200 may be composed of multiple physically separate components (e.g. a NodeB component and a RNC component, or a BTS component and a BSC component, etc.), which may each have their own respective components. In certain scenarios in which the network node 1200 comprises multiple separate components (e.g. BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g. separate memory 1204 for different RATs) and some components may be reused (e.g. a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality. For example, the processing circuitry 1202 may be configured to cause the network node to perform the methods as described with reference to FIG. 10.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signalling and/or data between network nodes, the access network, the core network, and/or a UE. As illustrated, the communication interface 1206 comprises port(s)/terminal(s) 1216 to send and receive data, for example to and from a network over a wired connection.

The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the access network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g. at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g. the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

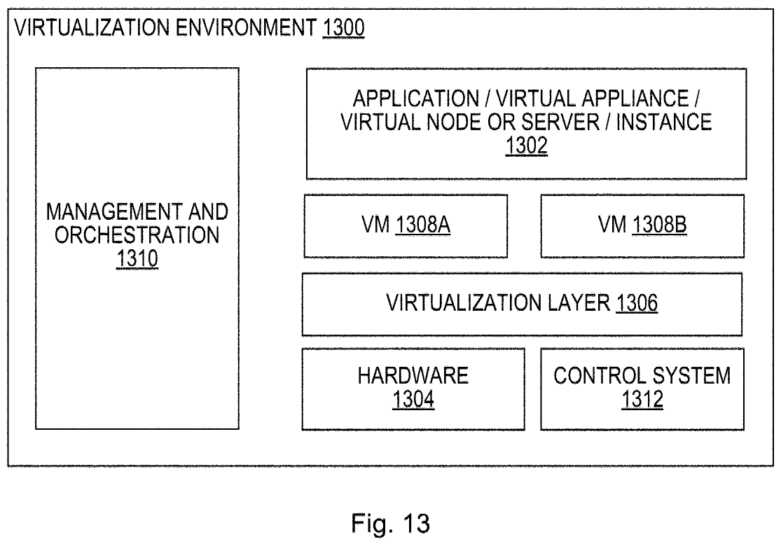

FIG. 13 is a block diagram illustrating a virtualization environment 1300 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1300 hosted by one or more of hardware nodes, such as a hardware computing device that operates as an access network node, or a wireless device/UE.

Applications 1302 (which may alternatively be called software instances, virtual appliances, network functions, virtual nodes, virtual network functions, etc.) are run in the virtualization environment 1300 to implement some of the features, functions, and/or benefits of some of the embodiments disclosed herein.

Hardware 1304 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1306 (also referred to as hypervisors or virtual machine monitors (VMMs)), provide VMs 1308a and 1308b (one or more of which may be generally referred to as VMs 1308), and/or perform any of the functions, features and/or benefits described in relation with some embodiments described herein. The virtualization layer 1306 may present a virtual operating platform that appears like networking hardware to the VMs 1308.

The VMs 1308 comprise virtual processing, virtual memory, virtual networking or interface and virtual storage, and may be run by a corresponding virtualization layer 1306. Different embodiments of the instance of a virtual appliance 1302 may be implemented on one or more of VMs 1308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1308 may be a software implementation of a physical machine that runs programs as if they were executing on a physical, non-virtualized machine. Each of the VMs 1308, and that part of hardware 1304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1308 on top of the hardware 1304 and corresponds to the application 1302.

Hardware 1304 may be implemented in a standalone network node with generic or specific components. Hardware 1304 may implement some functions via virtualization. Alternatively, hardware 1304 may be part of a larger cluster of hardware (e.g. such as in a data center or CPE) where many hardware nodes work together and are managed via management and orchestration 1310, which, among others, oversees lifecycle management of applications 1302. In some embodiments, hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signalling can be provided with the use of a control system 1312 which may alternatively be used for communication between hardware nodes and radio units.

Although the computing devices described herein (e.g. wireless devices, UEs, network nodes) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

1-45. (canceled)

46. A method performed by a first wireless device configured for sidelink (SL) communications with other wireless devices, the method comprising:
communicating with a second wireless device via SL communications, using a first configured beam for sending SL communications to the second wireless device and using a second configured beam for receiving SL communications from the second wireless device; and
responsive to detecting beam failure for the second configured beam, attempting to recover SL communications from the second wireless device by transmitting beam failure recovery (BFR) signaling to the second wireless device or a network node of an access network, the BFR signaling transmitted using at least one of the first configured beam or a different beam.

47. The method as claimed in claim 46, wherein the BFR signaling comprises information relating to one or more candidate beams usable for further communications from the second wireless device to the first wireless device.

48. The method as claimed in claim 46, wherein the step of transmitting BFR signaling to the second wireless device comprises, as an initial recovery attempt, transmitting the BFR signaling to the second wireless device via the first configured beam.

49. The method as claimed in claim 48, wherein the initial recovery attempt comprises transmitting the BFR signaling for the second wireless device via the first configured beam one or more times until a positive acknowledgement of the BFR signaling is received from the second wireless device or a limit on transmission repetitions is reached.

50. The method as claimed in claim 48, wherein, with respect to repeating transmissions of the BFR signaling during the initial recovery attempt, the method includes using a higher transmission power for transmissions subsequent to an initial transmission.

51. The method as claimed in claim 48, further comprising performing a further recovery attempt responsive to the initial recovery attempt being unsuccessful, the further recovery attempt comprising at least one of:
transmitting the BFR signaling for reception by the second wireless device, using a transmit beam that is different than the first configured beam; or
transmitting the BFR signaling for reception by the network node, using a transmit beam used for sending communications to the network node.

52. The method as claimed in claim 51, wherein performing the further recovery attempt comprises firstly attempting recovery by transmitting the BFR signaling for reception by the second wireless device, using a transmit beam that is different than the first configured beam, and then, responsive to receiving no positive acknowledgement form the second wireless device, secondly attempting recovery by transmitting the BFR signaling for reception by the network node, using a transmit beam having a directionality corresponding to the network node.

53. The method as claimed in claim 46, wherein transmitting beam failure recovery (BFR) signaling to the second wireless device or the network node comprises at least one of: transmitting the BFR signaling for reception by the network node, based on using a transmit beam corresponding to the network node, or transmitting the BFR signaling for reception by the second wireless device, using a transmit beam having a same beam direction as the first configured beam but having a wider beam width, or using a transmit beam that is reciprocal with the second configured beam.

54. The method as claimed in claim 53, further comprising, for transmitting the BFR signaling for reception by the second wireless device, the method includes choosing the transmit beam that is different than the first configured transmit beam based on any one of:
selecting the different transmit beam as a beam having a directionality corresponding to the first configured beam but having a wider beam width;
selecting the different transmit beam based on signal quality measurements;
selecting the different transmit beam based on signal quality measurements received from the second wireless device;
selecting the different transmit beam as a candidate beam that has a highest signal quality;
selecting the different transmit beam from a set of candidate beams whose signal quality is above a threshold; or
selecting the different transmit beam based on performing beam sweeping of candidate beams.

55. The method as claimed in claim 46, wherein attempting to recover SL communications from the second wireless device by transmitting the BFR signaling comprises transmitting the BFR signaling for reception by the second wireless device, using a transmit beam that is wider than the first configured beam.

56. The method as claimed in claim 46, wherein the method further comprises detecting beam failure of the first configured beam, based on detecting one or more of:
reaching a threshold number of consecutive Hybrid Automatic Repeat Request (HARQ) Discontinuous Transmissions (DTXs), for transmissions to the second wireless device via the first configured beam; or
reaching a threshold number of upper layer retransmissions of communications to the second wireless device via the first configured beam.

57. The method as claimed in claim 56, wherein the threshold number of consecutive HARQ DTXs or the threshold number of upper layer retransmissions is set to a value lower than a corresponding threshold number used to detect radio link failure (RLF).

58. The method as claimed in claim 56, further comprising, responsive to detecting beam failure for the first configured beam, the method further comprises one or more of:
suspending transmission of communications to the second wireless device via the first configured beam until another beam to the second wireless device is recovered; and
transmitting further communications to the second wireless device via a plurality of beams until at least one among the plurality of beams is recovered.

59. A method performed by a second wireless device configured for sidelink (SL) communications with other wireless devices, the method comprising:
communicating with a first wireless device via SL communications, using a first configured beam for receiving SL communications from the first wireless device and using a second configured beam for sending SL communications to the first wireless device; and
receiving beam failure recovery (BFR) signaling from the first wireless device or from a network node of an access network, the BFR signaling for recovering SL communications from the second wireless device to the first wireless device and received via the first configured beam or a different beam.

60. The method as claimed in claim 59, wherein the BFR signaling comprises information relating to one or more candidate beams that can be used for further SL communications from the second wireless device to the first wireless device.

61. The method as claimed in claim 59, wherein receiving the BFR signaling comprises receiving the BFR signaling from the first wireless device via the first configured beam.

62. The method as claimed in claim 59, wherein receiving the BFR signaling comprises receiving the BFR signaling from the first wireless communication device, using a reception beam that is wider than the first configured beam.

63. The method as claimed in claim 59, wherein receiving the BFR signaling comprises one of: receiving the BFR signaling from the first wireless device via a beam that is different than the first configured beam, or receiving the BFR signaling from the network node via a beam used for communicating with the network node.

64. A first wireless device comprising:
a communication interface comprising radiofrequency (RF) transceiver circuitry that is configured for sending sidelink (SL) communications to and receiving SL communications from a second wireless device; and
processing circuitry operatively associated with the communication interface and configured to:
communicate with the second wireless device via SL communications, using a first configured beam for sending SL communications to the second wireless device and using a second configured beam for receiving SL communications from the second wireless device; and
responsive to detecting beam failure for the second configured beam, attempt to recover SL communications from the second wireless device by transmitting beam failure recovery (BFR) signaling to the second wireless device or a network node of an access network, the BFR signaling transmitted using at least one of the first configured beam or a different beam.

65. A second wireless device comprising:
a communication interface comprising radiofrequency (RF) transceiver circuitry that is configured for sending sidelink (SL) communications to and receiving SL communications from a first wireless device; and
processing circuitry operatively associated with the communication interface and configured to:
communicate with the first wireless device via SL communications, using a first configured beam for receiving SL communications from the first wireless device and using a second configured beam for sending SL communications to the first wireless device; and
receive beam failure recovery (BFR) signaling from the first wireless device or from a network node of an access network, the BFR signaling for recovering SL communications from the second wireless device to the first wireless device and received via the first configured beam or a different beam.
